(19) United States
(12) Patent Application Publication
(10) Pub. No.: US 2024/0330412 A1
(43) Pub. Date: Oct. 3, 2024

(54) COLUMN CLASSIFICATION MODEL

(71) Applicant: Snowflake Inc., Bozeman, MT (US)

(72) Inventors: Zachary Charles Frazier, Seattle, WA (US); Stephen Joe Jonany, Seattle, WA (US); Yimeng Li, Bellevue, WA (US); Nabajyoti Patowary, Seattle, WA (US); Chao Tan, Issaquah, WA (US); Yunqiao Zhang, Bellevue, WA (US)

(21) Appl. No.: 18/192,243

(22) Filed: Mar. 29, 2023

(51) Int. Cl. G06F 18/241; G06F 16/22

(52) U.S. Cl. CPC G06F 18/241; G06F 16/221

(57) ABSTRACT

Systems and methods for classifying columns using a model are provided. The systems and methods access a table associated with a column of features and retrieve a list of categories each associated with a different scoring model. The systems and methods, for each category in the list of categories, apply a respective scoring model to the features of the column to generate a respective set of confidence values indicating a likelihood that the column belongs to a respective one of the categories. The systems and methods process the respective sets of confidence values to select a target category from the list of categories and associate the selected target category with the column.

### TECHNICAL FIELD

Embodiments of the disclosure relate generally to data platforms and databases and, more specifically, to classifying columns of tables.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Databases are used by various entities and companies for storing information that may need to be accessed or analyzed. Various operations performed on a database, such as joins and unions, involve combining query results obtained from different data sources (e.g., different tables, possibly on different databases) into a single query result. The various operations that can be performed on the databases are controlled based on access privileges of requesting entities.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based data platform, in accordance with some embodiments of the present disclosure.

FIG. 2 is a block diagram illustrating components of a compute service manager, in accordance with some embodiments of the present disclosure.

FIG. 3 is a block diagram illustrating components of an execution platform, in accordance with some embodiments of the present disclosure.

FIG. 4 is a block diagram of a column classification manager, in accordance with some embodiments of the present disclosure.

FIGS. 5 and 6 are illustrative outputs of the column classification manager, in accordance with some embodiments of the present disclosure.

FIG. 7 is a flow diagram illustrating a method of the column classification manager, in accordance with some embodiments of the present disclosure.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

In a typical implementation, a data platform includes one or more databases that are maintained on behalf of a customer account. The data platform may include one or more databases that are respectively maintained in association with any number of customer accounts, as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata in association with the data platform in general and in association with, as examples, particular databases and/or particular customer accounts as well. The database can include one or more objects, such as tables, functions, and so forth.

Users and/or executing processes that are associated with a given customer account may, via one or more types of clients, be able to cause data to be ingested into the database, and may also be able to manipulate the data, add additional data, remove data, run queries against the data, generate views of the data, and so forth. In an example implementation of a data platform, a given database is represented as an account-level object within a customer account, and the customer account may also include one or more other account-level objects such as users, roles, and/or the like. Furthermore, a given account-level database object may itself contain one or more objects such as tables, schemas, views, streams, tasks, and/or the like.

A given table may be organized as records (e.g., rows or a collection of rows) that each include one or more attributes (e.g., columns). A data platform may physically store database data in multiple storage units, which may be referred to as blocks, micro-partitions, and/or by one or more other names. In an example, a column of a database can be stored in a block and multiple blocks can be grouped into a single file. That is, a database can be organized into a set of files where each file includes a set of blocks. Consistent with this example, for a given column, all blocks are stored contiguously and blocks for different columns are row aligned. Data stored in each block can be compressed to reduce its size. A block storing compressed data may also be referred to as a “compression block” herein. As referred to herein, a “record” is defined as a collection of data (e.g., textual data) in a file that is organized by one or more fields, where each field can include one or more respective data portions (e.g., textual data, such as strings). Each field in the record can correspond to a row or column of data in a table that represents the records in the file. It should be understood that the terms “row” and “column” are used for illustration purposes and these terms are interchangeable. Data arranged in a column of a table can similarly be arranged in a row of the table.

In many cases, the columns of a table may need to be classified, such as to assign different category labels to the columns. These category labels can assist with performing different operations on the columns and in the presentation of information stored in the columns. Conventional systems usually apply category rules to the entries of the columns to determine to which category a column belongs. These rules are usually predefined and do not scale well with large datasets. Certain users may seek to introduce new categories and define new rules but conventional systems do not provide a mechanism to allow for new rules to be defined. In addition, even with these rules, classifying categories accurately is still challenging and requires manual review of the assigned classifications. The need to manually review such classifications for each column is tedious and prone to errors. This can introduce inefficiencies and these systems cannot be applied on a large scale to tables with a large number of columns that need to be classified. The process of manually reviewing classifications and potentially erroneously classifying columns is time consuming, inefficient, and prone to human error, which can result in a waste of time and network and processing device resources.

Aspects of the present disclosure include systems, methods, and devices to address, among other problems, the aforementioned shortcomings of conventional data platforms by intelligently classifying columns and providing a unique approach to allow customers to define new classification rules and/or models, such as machine learning models. The disclosed techniques access a table associated with features of a column and retrieve a list of categories each associated with a different scoring model. The disclosed techniques, for each category in the list of categories, apply a respective scoring model to the features of the column to generate a respective set of confidence values indicating a likelihood that the column belongs to a respective one of the categories. The disclosed techniques process the respective sets of confidence values to select a target category from the list of categories and associate the selected target category with the column. This saves a great deal of time and effort and prevents propagation of errors, which improves the overall efficiency of the system.

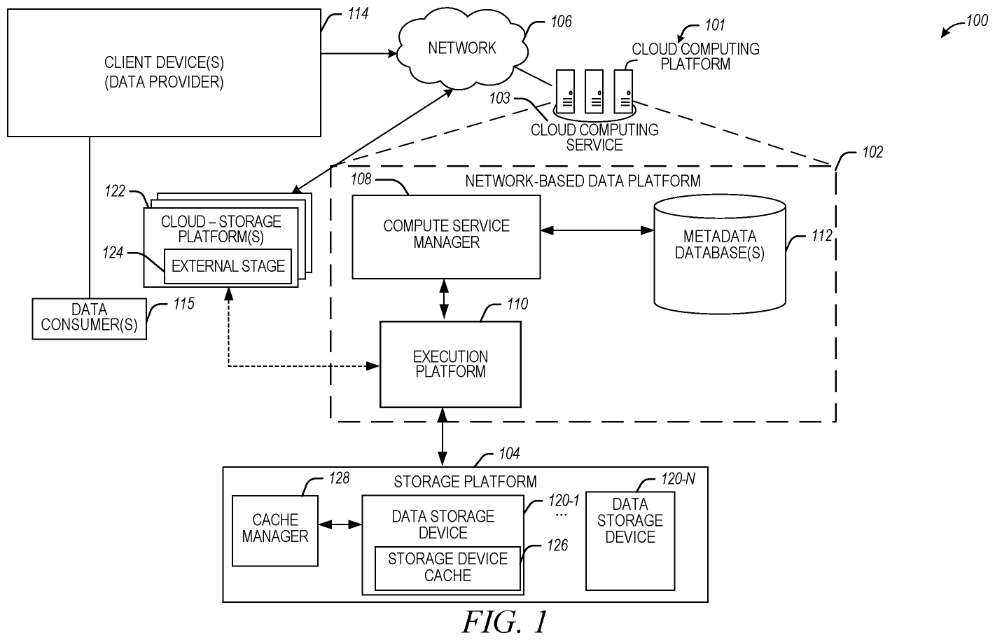

FIG. 1 illustrates an example computing environment 100 that includes a data platform in the example form of a network-based data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based data platform 102 and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., structured query language (SQL) queries, analysis), as well as other processing capabilities (e.g., parallel execution of sub-plans, as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (e.g., one or more external storage locations). For example, a company could be a customer of a particular data platform and also separately maintain storage of any number of files (unstructured files, semi-structured files, structured files, and/or files of one or more other types) on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform. The techniques described in this disclosure pertain to non-volatile storage devices that are used for the internal storage location and/or the external storage location.

From the perspective of the network-based data platform 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location. For example, in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based data platform 102 of the cloud computing platform 101 is in communication with the cloud storage platforms 104 and 122 (e.g., Amazon Web Services (AWS)®, Microsoft Azure Blob Storage®, or Google Cloud Storage). The network-based data platform 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based data platform 102.

The network-based data platform 102 comprises a compute service manager 108, an execution platform 110, and one or more metadata databases 112. The network-based data platform 102 hosts and provides data reporting and analysis services to multiple client accounts.

The compute service manager 108 coordinates and manages operations of the network-based data platform 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based data platform 102. A user may utilize the client device 114 to submit data storage, retrieval, and analysis requests to the compute service manager 108. Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices that may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, notification to a user may be understood to be a notification transmitted to client device 114, input or instruction from a user may be understood to be received by way of the client device 114, and interaction with an interface by a user shall be understood to be interaction with the interface on the client device 114 by a data consumer 115. In addition, database operations (joining, aggregating, analysis, inserting, deleting, updating, etc.) ascribed to a user (consumer or provider) shall be understood to include performing such actions by the cloud computing service 103 in response to an instruction from that user, such as using an SQL query or command.

Some database operations performed by the compute service manager 108 can include an operation to classify one or more columns of a table in a result or response to a query received from a client device 114. Specifically, the compute service manager 108 can receive a request to access or perform an operation on a table from the client device 114. The compute service manager 108 can determine classifications associated with one or more columns of the table. In response, the compute service manager 108 formulates a response to the query in which the one or more columns of data that are classified are returned in the results.

The compute service manager 108 is also coupled to one or more metadata databases 112 that store metadata about various functions and aspects associated with the network-based data platform 102 and its users. The metadata database 112 can store the table that provides the mapping between sessions, references to objects, identity of objects, and/or access privileges of the objects. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata.

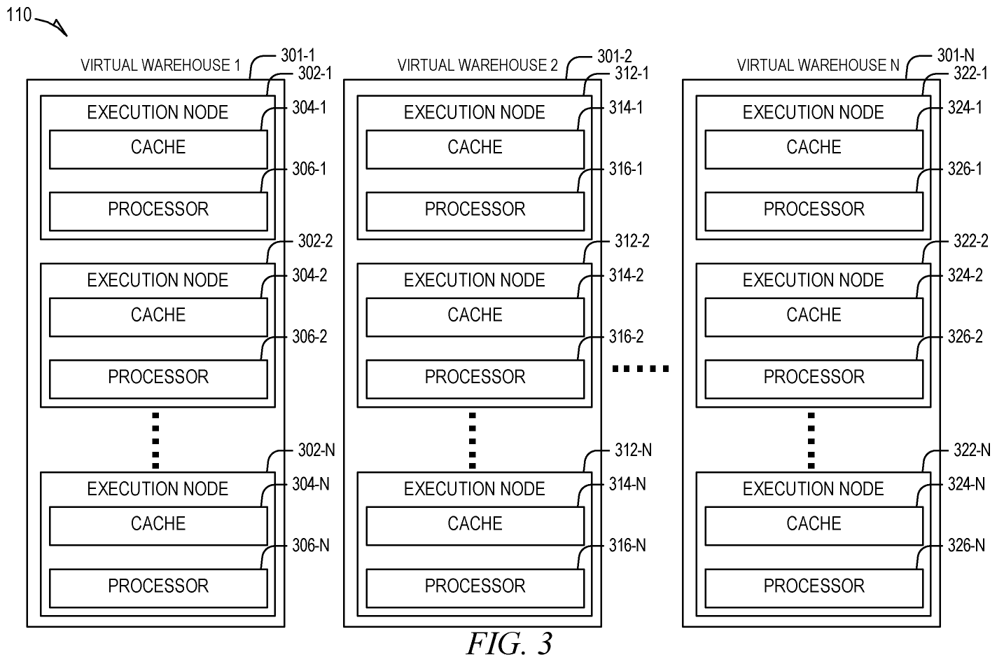

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like.

In some embodiments, at least one storage device cache 126 (e.g., an internal cache) may reside on one or more of the data storage devices 120-1 to 120-N, and at least one external stage 124 may reside on one or more of the cloud storage platforms 122. In some examples, a single storage device cache 126 can be associated with all of the data storage devices 120-1 to 120-N so that the single storage device cache 126 is shared by and can store data associated with any one of the data storage devices 120-1 to 120-N. In some examples, each data storage device of storage devices 120-1 to 120-N can include or implement a separate storage device cache 126. A cache manager 128 handles the transfer of data from the data storage devices 120-1 to 120-N to the storage device cache 126. The cache manager 128 handles the eviction of data from the storage device cache 126 to the respective associated data storage devices 120-1 to 120-N. The storage platform 104 can include one or more hard drives and/or can represent a plurality of hard drives distributed on a plurality of servers in a cloud computing environment.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-networks) coupled to one another. In alternate embodiments, these communication links are implemented using any type of communication medium and any communication protocol.

The compute service manager 108, metadata database(s) 112, execution platform 110, and storage platform 104 are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based data platform 102. Thus, in the described embodiments, the network-based data platform 102 is dynamic and supports regular changes to meet the current data processing needs.

During a typical operation, the network-based data platform 102 processes multiple jobs (e.g., operators of sub-plans) determined by the compute service manager 108. These jobs (e.g., caller processes) are scheduled and managed by the compute service manager 108 to determine when and how to execute the job. For example, the compute service manager 108 may divide the job into multiple discrete tasks (e.g., caller processes) and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task (e.g., in a storage device cache 126, such as an HDD cache or random access memory (RAM)) and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

According to various embodiments, the execution platform 110 executes a query according to a query plan determined by the compute service manager 108. As part of executing the query, the execution platform performs a table scan in which one or more portions of a database table are scanned to identify data that matches the query. More specifically, the database table can be organized into a set of files where each file comprises a set of blocks (or records) and each block (or record) stores at least a portion of a column (or row) of the database. Each execution node provides multiple threads of execution, and in performing a table scan, multiple threads perform a parallel scan of the set of blocks (or records) of a file, which may be selected from a scan set corresponding to a subset of the set of files into which the database is organized. The query plan, in some cases, can include a request to organize data from a structured or unstructured text file into one or more tables.

The cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

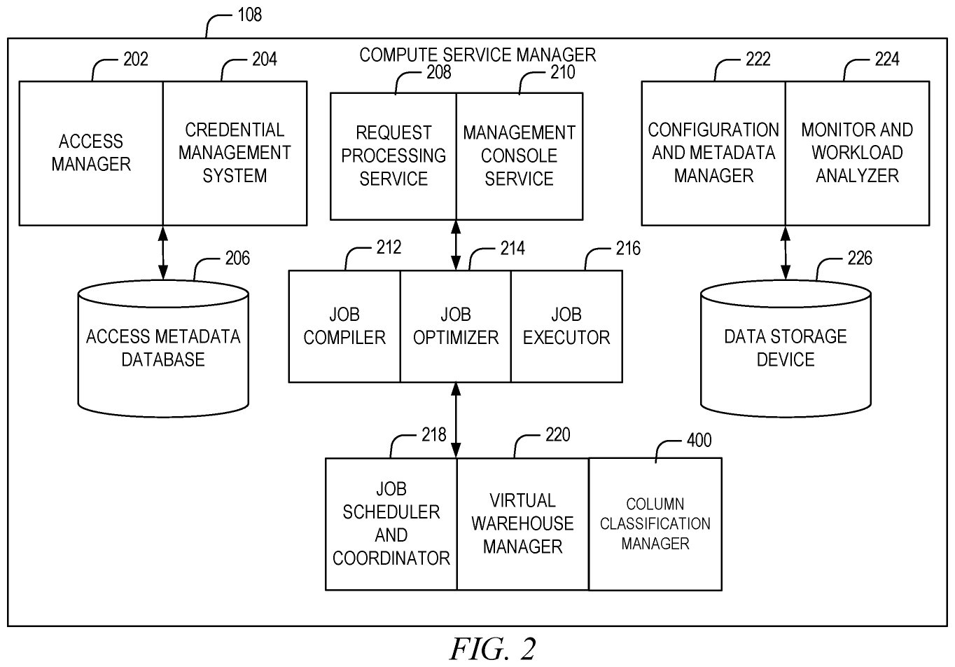

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources such as data resources in a remote storage device. As used herein, the remote storage devices may also be referred to as “persistent storage devices,” “non-volatile storage devices,” “cloud storage devices,” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110, in a storage device cache 126, or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries by one or more execution nodes of the execution platform 110. In some cases, the compute service manager 108 includes a column classification manager 400, discussed in more detail below, to handle jobs of the job executor 216.

Additionally, the compute service manager 108 includes a configuration and metadata manager 222, which manages the information related to the data stored in the remote data storage devices and the local buffers (e.g., the buffers in execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based data platform 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based data platform 102. For example, data storage device 226 may represent buffers in execution platform 110, storage devices in storage platform 104, or any other storage device.

FIG. 3 is a block diagram illustrating components of the execution platform 110, which can be implemented by any of the virtual warehouses of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing data from any of the data storage devices 120-1 to 120-N and their associated storage device cache 126 (e.g., via a respective lock file) shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104. The techniques described with respect to the cache manager 128 of the storage platform 104 (e.g., an HDD) can be similarly applied to the cache 304-N, 314-N, and 324-N of the execution nodes 302-N, 312-N, and 322-N.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

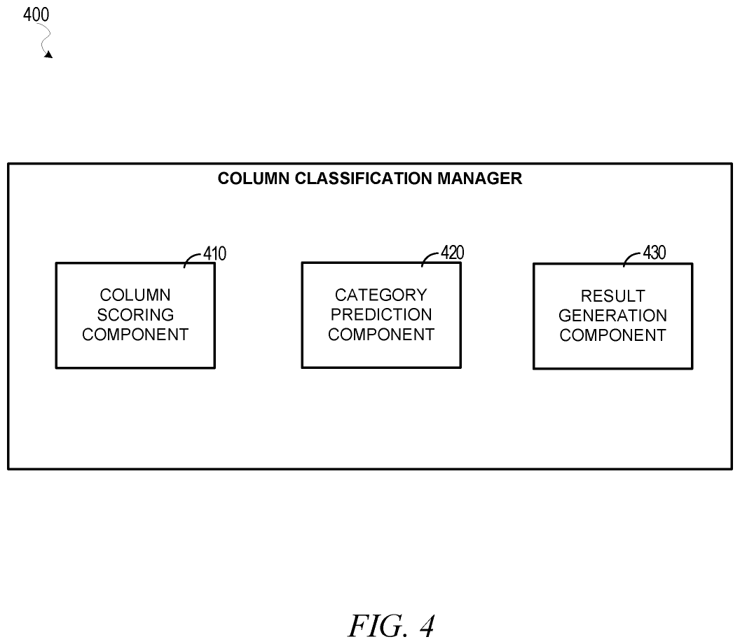

FIG. 4 is a block diagram illustrating an example of the column classification manager 400, which can be implemented by any of the virtual warehouses of the execution platform 110, such as the execution node 302-1, compute service manager 108, and/or the request processing service 208, in accordance with some embodiments of the present disclosure. The column classification manager 400 can include a column scoring component 410, a category prediction component 420, and a result generation component 430. Below is a general discussion of the column classification manager 400 followed by a detailed description of operation of the individual components of the column classification manager 400.

Starting with the general discussion of the column classification manager 400, the column classification manager 400 is configured to access a table comprising a column of data from which features are computed and retrieves a list of categories each associated with a different scoring model. The column classification manager 400, for each category in the list of categories, applies a respective scoring model to the features of the column to generate a respective set of confidence values indicating a likelihood that the column belongs to a respective one of the categories. The column classification manager 400 processes the respective sets of confidence values to select a target category from the list of categories and associates the selected target category with the column of features.

In some examples, the features include data entries of the column and/or a column name. In some examples, the column classification manager 400, for a first category in the list of categories, applies a first scoring model to the features in the column to generate a first set of confidence values indicating a likelihood that the column belongs to the first category. In some cases, the column classification manager 400, for a second category in the list of categories, applies a second scoring model to the features in the column to generate a second set of confidence values indicating a likelihood that the column belongs to the second category. The column classification manager 400 processes the first set of confidence values and the second set of confidence values to select the target category for the column from the first and second categories.

In some examples, each confidence value (e.g., a certainly, likely, or unknown confidence value) in the respective sets of confidence values can be associated with a different score. In some examples, the scoring model generates a distribution of scores for the features of the column as belonging to a first category in the list of categories as a first set of confidence values. The distribution of scores can include a first percentage of the features of the column having a first likelihood of belonging to the first category. A second percentage of the features of the column can have a second likelihood of belonging to the first category and a third percentage of the features of the column can have a third likelihood of belonging to the first category.

In some examples, the first likelihood is greater than the second likelihood and the second likelihood is greater than the third likelihood. In some examples, the column classification manager 400 determines that the first percentage is greater than a threshold value. The column classification manager 400, in response to determining that the first percentage is greater than the threshold value, generates an aggregate confidence value that the column belongs to the first category as a sum of a first portion of confidence values of the first set of confidence values associated with the first likelihood and a second portion of confidence values of the first set of confidence values associated with the second likelihood.

In some examples, the column classification manager 400 determines that a first feature of the column of features includes a column name. For example, the column classification manager 400 can determine that a first feature of the column has a corresponding high confidence feature (or confidence feature that transgresses a specified threshold) computed from the column name. In such cases, the column classification manager 400 obtains a confidence value from the first set of confidence values corresponding to the first feature including the column name and selectively increases the aggregate confidence value by a first amount or a second amount based on the confidence value of the first feature including the column name, the second amount being smaller than the first amount. In some examples, the column classification manager 400 determines that the confidence value corresponds to the first likelihood. The column classification manager 400, in response to determining that the confidence value of the first feature including the column name corresponds to the first likelihood, increases the aggregate confidence value by the first amount. In some examples, the column classification manager 400 determines that the confidence value corresponds to the second likelihood and, in response, increases the aggregate confidence value by the second amount.

In some examples, the aggregate confidence value is a first aggregate confidence value. The column classification manager 400 generates a second aggregate confidence value that the column belongs to a second category based on a second set of confidence values associated with the features of the column. The column classification manager 400 compares the first aggregate confidence value with the second aggregate confidence value and selects the target category from the first and second categories in response to comparing the first aggregate confidence value with the second aggregate confidence value.

In some examples, the column classification manager 400 determines that the second aggregate confidence value is greater than the first aggregate confidence value in response to comparing the first aggregate confidence value with the second aggregate confidence value. The column classification manager 400 selects the second category as the target category in response to determining that the second aggregate confidence value is greater than the first aggregate confidence value.

In some examples, the column classification manager 400 accesses a plurality of machine learning models each associated with a different category in the list of categories. The column classification manager 400 applies a first machine learning model of the plurality of machine learning models to the features in the column to generate a first set of confidence values corresponding to a first category in the list of categories. In some examples, the column classification manager 400 applies a second machine learning model of the plurality of machine learning models to the features in the column to generate a second set of confidence values corresponding to a second category in the list of categories.

In some examples, the scoring model for a first category includes a predefined list of attributes associated with the first category. In such cases, the column classification manager 400 determines that a first feature of the column of features matches one or more attributes in the predefined list of attributes and generates a first confidence value (e.g., certainly) of a first set of confidence values of the column for the first feature based on determining that the first feature of the column of features matches the one or more attributes in the predefined list of attributes. In some examples, the column classification manager 400 determines that a second feature of the column of features fails to match the one or more attributes in the predefined list of attributes and generates a second confidence value (e.g., unknown or likely) of the first set of confidence values of the column for the second feature based on determining that the second feature of the column of features fails to match the one or more attributes in the predefined list of attributes. In some examples, the column classification manager 400 computes the first set of confidence values for the column as a function of the first and second confidence values.

Continuing with reference to FIG. 4, below is a detailed discussion of the individual components of the column classification manager 400. Specifically, as explained below, the column scoring component 410 receives a reference to a table (manually from a query or automatically) and computes features of data contained in each column of the table. The column scoring component 410 generates confidence values for each category of a set of categories for the features of the columns and provides such confidence values to the category prediction component 420. The category prediction component 420 aggregates the confidence values and applies one or more functions to the confidence values of the categories and selects a target category to associate with each column of the table. The target category is output as a classification by a result generation component 430.

For example, the column scoring component 410 can receive a query from a client device 114 to generate a classification for one or more columns of a table. The query can specify which columns to classify such that less than all columns of the table are classified. In some cases, the column scoring component 410 can automatically identify a table that is missing classifications for columns of the table and automatically processes the columns to generate classifications for the columns. Generating classifications, as described herein, refers to assigning one or more categories, semantic categories, and/or labels to columns to identify the type of data that is being stored by the entries of the column. A column can include multiple data or information from which features can be computed or generated, such data or information can include a column name and/or data entries. The features can represent the fraction of cells that contain strings with a specified pattern, a similarity between text in the column to English written text, and so forth.

The column scoring component 410 can, in some cases, receive from the client device 114 a classification and/or category and a set of rules and/or machine learning scoring model associated with the classification and/or category. The column scoring component 410 can store the received classification and associated rules/machine learning model in association with a table specific to the user of the client device 114. The column scoring component 410 can use the classification and associated rules/machine learning model to classify columns of other columns or tables that are associated with a different user/customer/entity if the client device 114 provides authorization for such use.

In some examples, the column scoring component 410 accesses the table and columns of the table identified by the client device 114 in the query. The column scoring component 410 can retrieve a set of classifications stored in association with the client device 114 and their corresponding scoring models. Specifically, the column scoring component 410 can access a database that includes multiple categories. Each category can be associated with a different set of rules and/or machine learning models that are used to generate confidence values/scores for different values of a column. In some cases, a first category can be associated with a list of predefined attributes. If an entry of an individual column received from the column scoring component 410 by accessing the column matches one of the predefined attributes or matches a threshold quantity of attributes and/or rules of the category, the column scoring component 410 assigns to the entry a first confidence value (e.g., certain) associated with a first likelihood that the entry belongs to the first category. If the entry received from the column scoring component 410 by accessing the column matches one attribute but less than the threshold quantity of attributes and/or rules of the category, the column scoring component 410 assigns to the entry a second confidence value (e.g., likely) associated with a second likelihood that the entry belongs to the first category. If the entry received from the column scoring component 410 by accessing the column matches none of the attributes and/or rules of the category, the column scoring component 410 assigns to the entry a third confidence value (e.g., unknown) associated with a third likelihood that the entry belongs to the first category. The first confidence value (e.g., a value of 0.9) can be greater than the second confidence value (e.g., a value of 0.5), and the second confidence value can be greater than the third confidence value (e.g. a value of 0).

The column scoring component 410 can, in some cases, identify a second category that is associated with a previously trained machine learning model. The machine learning model may have been previously trained, based on training data, to generate confidence value (e.g., certainly, likely, and/or unknown) for data entries. Namely, the training data can include training entries and ground truth confidence values associated with different likelihoods that each data entry belongs to the second category. The machine learning model can select a first training data entry and generate a first confidence value for the first training data entry. The machine learning model can retrieve the ground truth confidence value for the first training data entry. The machine learning model can compare the first confidence value with the ground truth confidence value to compute a deviation. Parameters of the machine learning model are updated based on the deviation. Then another training data entry or batch of training data entries are processed in a similar manner to continue updating parameters of the machine learning model until a stopping criterion is reached. The trained machine learning model can receive, as input, the entries of the column from the column scoring component 410. The trained machine learning model can then output confidence values for each entry or feature (e.g., data entry and/or column name) of the individual column received from the column scoring component 410. The column scoring component 410 can then store these confidence values in association with the second category for the individual column.

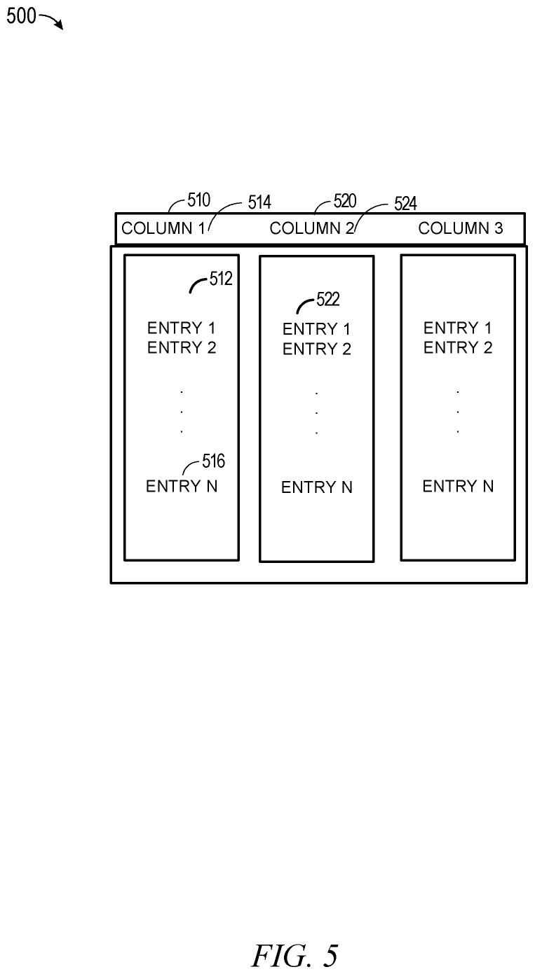

The column scoring component 410 obtains and/or accesses features of each column of the table and uses the rules and/or machine learning models of each category to generate confidence values for each entry or feature of each column of the table. Namely, as shown in FIG. 5, the column scoring component 410 can access a table 500. The column scoring component 410 can select a first column 510 from the table 500 which includes a column name 514 (e.g., a first feature) and one or more data entries 512 (e.g., a second feature). The column scoring component 410 applies the rules and/or machine learning models of each category to the features of the first column to generate a first set of confidence values for each feature (e.g., data entry and/or column name) of the first column. The column scoring component 410 again selects a second column 520 (which includes a column name 524 and one or more data entries 522) and applies the rules and/or machine learning models of each category to the features of the second column 520 to generate a first set of confidence values for each feature (e.g., data entry and/or column name) of the second column. Once all of the columns of the table 500 are processed in this manner, the column scoring component 410 outputs, for each of the plurality of categories, a list of confidence values for each feature of each column of the table. This output is provided to the category prediction component 420.

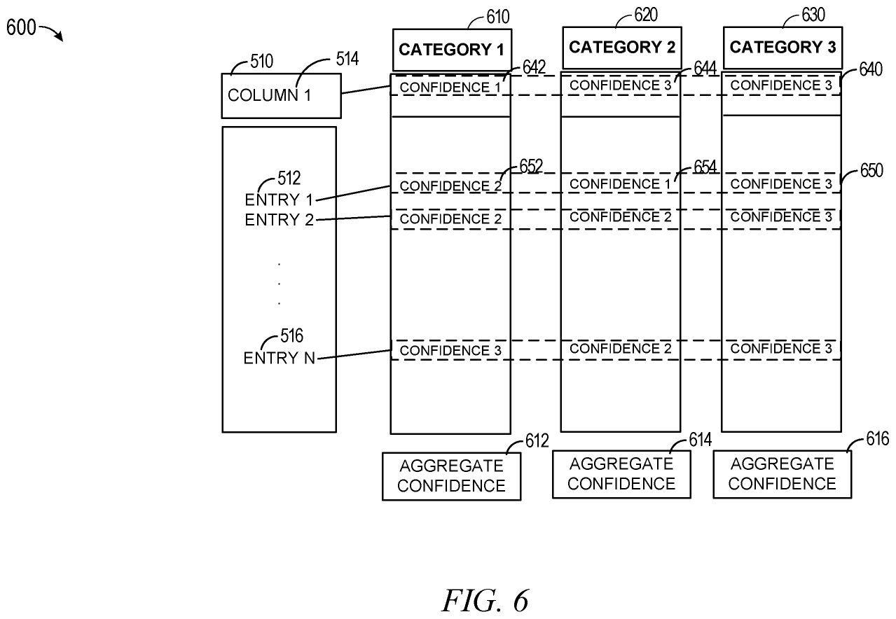

For example, as shown in the list of confidence values 600 of FIG. 6, the column scoring component 410 generates for a first category 610, a set of confidence values 642 and 652. Namely, the column scoring component 410 can apply a rule and/or model associated with the first category 610 to the column name 514 of the first column 510. The rule and/or model provides a first confidence value 642 (e.g., certainly), which is stored in association with the first category 610 for the first column 510. Similarly, the column scoring component 410 can apply the rule and/or model associated with the first category 610 to the one or more data entries 512 of the first column 510. The rule and/or model provides a second confidence value 652 (e.g., likely), which is stored in association with the first category 610 for the first column 510. The column scoring component 410 can apply the rule and/or model associated with the first category 610 to the one or more additional data entries 516 of the first column 510. The rule and/or model provides a third confidence value (e.g., unknown), which is stored in association with the first category 610 for the first column 510.

As further shown in FIG. 6, the column scoring component 410 generates for a second category 620, a set of confidence values 644 and 654. Namely, the column scoring component 410 can apply a rule and/or model associated with the second category 620 to the column name 514 of the first column 510. The rule and/or model provides a third confidence value 644 (e.g., unknown), which is stored in association with the second category 620 for the first column 510. Similarly, the column scoring component 410 can apply the rule and/or model associated with the second category 620 to the one or more data entries 512 of the first column 510. The rule and/or model provides a first confidence value 654 (e.g., certainly), which is stored in association with the second category 620 for the first column 510. The column scoring component 410 can apply the rule and/or model associated with the second category 620 to the one or more additional data entries 516 of the first column 510. The rule and/or model provides a second confidence value (e.g., likely), which is stored in association with the second category 620 for the first column 510.

As further shown in FIG. 6, the column scoring component 410 generates for a third category 630, a set of confidence values 640 and 650. Namely, the column scoring component 410 can apply a rule and/or model associated with the third category 630 to the column name 514 of the first column 510. The rule and/or model provides a third confidence value 640 (e.g., unknown), which is stored in association with the third category 630 for the first column 510. Similarly, the column scoring component 410 can apply the rule and/or model associated with the third category 630 to the one or more data entries 512 of the first column 510. The rule and/or model provides a third confidence value 650 (e.g., unknown) which is stored in association with the third category 630 for the first column 510. The column scoring component 410 can apply the rule and/or model associated with the third category 630 to the one or more additional data entries 516 of the first column 510. The rule and/or model provides a third confidence value (e.g., unknown), which is stored in association with the third category 630 for the first column 510.

The category prediction component 420 processes the confidence values stored for each category to generate an aggregate confidence value for each category. For example, the category prediction component 420 processes the set of confidence values 642 and the set of confidence values 652 of the first category 610 to generate a first aggregate confidence value 612 for the first category 610. Similarly, the category prediction component 420 processes the set of confidence values 644 and the set of confidence values 654 of the second category 620 to generate a second aggregate confidence value 614 for the second category 620. The category prediction component 420 processes the set of confidence values 640 and the set of confidence values 650 of the third category 630 to generate a third aggregate confidence value 616 for the third category 630. The category prediction component 420 then compares each of the aggregate confidence values of each category to a threshold value. The category prediction component 420 selects a target category from the plurality of categories (e.g., first category 610, second category 620, and/or third category 630) based on comparison between each of the aggregate confidence values of each category to the threshold value. In some examples, the category prediction component 420 determines that the second aggregate confidence value 614 of the second category 620 transgresses the threshold value and that the first aggregate confidence value 612 and the third aggregate confidence value 616 fail to transgress the threshold value. In such cases, the category prediction component 420 selects the second category 620 as the target category and provides the target category to the result generation component 430. In some examples, the category prediction component 420 selects the category that is associated with the greatest aggregate confidence value as the target category in addition to or instead of basing the selection on comparison of the aggregate confidence value to the threshold value.

For example, the category prediction component 420 can generate a distribution of confidence values for each of the plurality of categories. Namely, for the first category 610, the category prediction component 420 can compute how many data entries of the one or more data entries 512 and the one or more additional data entries 516 are associated with a first confidence value (e.g., a certainly confidence value). The category prediction component 420 can compute a first percentage as a ratio of the quantity of data entries that are associated with the first confidence value and a total number of data entries in the first column 510. Similarly, for the first category 610, the category prediction component 420 can compute how many data entries of the one or more data entries 512 and the one or more additional data entries 516 are associated with a second confidence value (e.g., a likely confidence value). The category prediction component 420 can compute a second percentage as a ratio of the quantity of data entries that are associated with the second confidence value and the total number of data entries in the first column 510. For the first category 610, the category prediction component 420 can compute how many data entries of the one or more data entries 512 and the one or more additional data entries 516 are associated with a third confidence value (e.g., an unknown confidence value). The category prediction component 420 can compute a third percentage as a ratio of the quantity of data entries that are associated with the third confidence value and the total number of data entries in the first column 510.

The category prediction component 420 performs similar operations for computing the percentages of the confidence values for each other category, such as the second category 620 and the third category 630. For example, for the second category 620, the category prediction component 420 can compute how many data entries of the one or more data entries 512 and the one or more additional data entries 516 are associated with a first confidence value (e.g., a certainly confidence value). The category prediction component 420 can compute, for the second category 620, a first percentage as a ratio of the quantity of data entries that are associated with the first confidence value and a total number of data entries in the first column 510. Similarly, for the second category 620, the category prediction component 420 can compute how many data entries of the one or more data entries 512 and the one or more additional data entries 516 are associated with a second confidence value (e.g., a likely confidence value). The category prediction component 420 can compute, for the second category 620, a second percentage as a ratio of the quantity of data entries that are associated with the second confidence value and the total number of data entries in the first column 510. For the second category 620, the category prediction component 420 can compute how many data entries of the one or more data entries 512 and the one or more additional data entries 516 are associated with a third confidence value (e.g., an unknown confidence value). The category prediction component 420 can compute, for the second category 620, a third percentage as a ratio of the quantity of data entries that are associated with the third confidence value and the total number of data entries in the first column 510.

In some examples, the category prediction component 420 compares the first percentage of the entries of the first column 510 that are associated with the first confidence value for the first category 610 to a threshold value. In response to determining that the first percentage transgresses the threshold value, the category prediction component 420 computes, as the first aggregate confidence value 612, for the first category 610, a sum of the first percentage and the second percentage of the entries of the first column 510 that are associated with the second confidence value. Similarly, the category prediction component 420 compares the first percentage of the entries of the first column 510 that are associated with the first confidence value for the second category 620 to the threshold value. In response to determining that the first percentage transgresses the threshold value, the category prediction component 420 computes, as the second aggregate confidence value 614, for the second category 620, a sum of the first percentage and the second percentage of the entries of the first column 510 that are associated with the second confidence value. The category prediction component 420 compares the first percentage of the entries of the first column 510 that are associated with the first confidence value for the third category 630 to the threshold value. In response to determining that the first percentage transgresses the threshold value, the category prediction component 420 computes, as the third aggregate confidence value 616, for the third category 630, a sum of the first percentage and the second percentage of the entries of the first column 510 that are associated with the second confidence value. For example, if the first percentage is greater than 0.9, the category prediction component 420 computes a sum of the first percentage (0.9) and the second percentage (0.01) as an aggregate confidence value.

In some examples, the category prediction component 420 selectively boosts or increases the aggregate confidence value computed for each category based on one or more criteria. For example, the category prediction component 420 can determine or retrieve the confidence value assigned to one of the features of the column (e.g., a name of the column). If the confidence value assigned to the one of the features transgresses a first threshold (e.g., is a likely confidence value), the category prediction component 420 increases the aggregate confidence value for the corresponding category by a first value or amount (e.g., increase the aggregate confidence value by 0.1 or 0.3 or some other value. If the confidence value assigned to the one of the features transgresses a second threshold that is greater than the first threshold (e.g., is a certainly confidence value), the category prediction component 420 increases the aggregate confidence value for the corresponding category by a second value or amount that is greater than the first value or amount.

For example, the category prediction component 420, for the first category 610, can retrieve the set of confidence values 642 associated with the column name 514 of the first column 510. The category prediction component 420 can determine that the set of confidence values 642 associated with the column name 514 transgresses the second threshold (e.g., the set of confidence values 642 is a certainly confidence value). In such cases, the category prediction component 420 increases the first aggregate confidence value 612 (previously computed based on the percentages of the entries of the one or more data entries 512 and the one or more additional data entries 516 associated with the first and second confidence values) by the second value or amount. As another example, the category prediction component 420, for the second category 620, can retrieve the set of confidence values 644 associated with the column name 514 of the first column 510. The category prediction component 420 can determine that the set of confidence values 644 associated with the column name 514 fails to transgress the second threshold but transgresses the first threshold (e.g., the set of confidence values 644 is a likely confidence value). In such cases, the category prediction component 420 increases the second aggregate confidence value 614 (previously computed based on the percentages of the entries of the one or more data entries 512 and the one or more additional data entries 516 associated with the first and second confidence values) by the first value or amount. For the third category 630, the category prediction component 420 can determine that the set of confidence values 640 associated with the column name 514 fails to transgress the first and second thresholds (e.g., the set of confidence values 640 is an unknown confidence value). In such cases, the category prediction component 420 does not change or can decrease (by some specified amount) the third aggregate confidence value 616 (previously computed based on the percentages of the entries of the one or more data entries 512 and the one or more additional data entries 516 associated with the first and second confidence values).

The result generation component 430 stores the target category in association with the first column 510. The result generation component 430 returns to the client device 114 the classification that includes the target category and performs one or more other operations on the table 500 based on the classification.

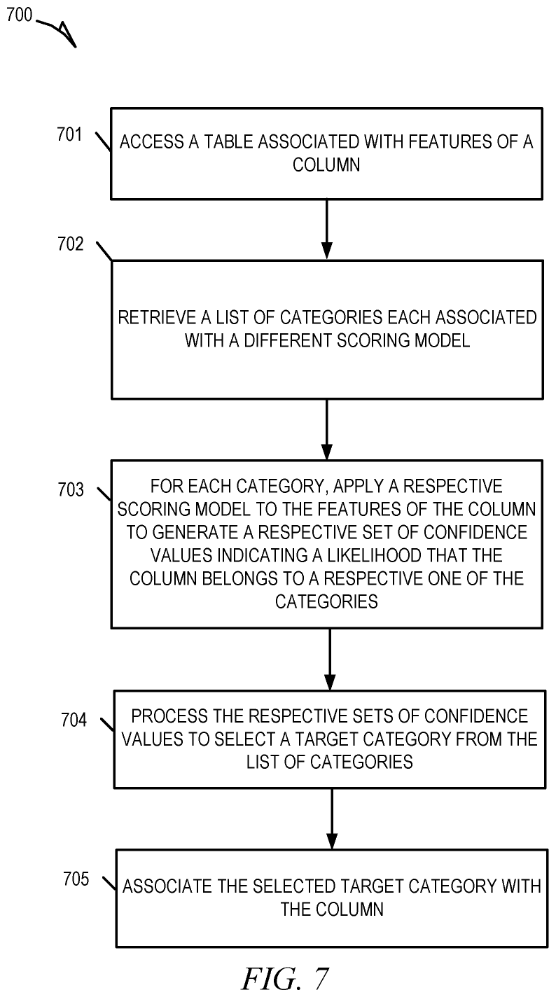

FIG. 7 is a flow diagram illustrating a method 700 of the column classification manager 400, in accordance with some embodiments of the present disclosure. The method 700 may be embodied in computer-readable instructions for execution by one or more hardware components (e.g., one or more processors) such that the operations of the method 700 may be performed by components of data platform 102 such as the execution platform 110. Accordingly, the method 700 are described below, by way of example with reference thereto. However, it shall be appreciated that method 700 may be deployed on various other hardware configurations and is not intended to be limited to deployment within the data platform 102. Depending on the embodiment, an operation of the method 700 may be repeated in different ways or involve intervening operations not shown. Though the operations of the method 700 may be depicted and described in a certain order, the order in which the operations are performed may vary among embodiments, including performing certain operations in parallel or performing sets of operations in separate processes.

At operation 701, the column classification manager 400 accesses a table comprising a column that includes a number of entries from which features are computed, as discussed above.

At operation 702, the column classification manager 400 retrieves a list of categories each associated with a different scoring model, as discussed above.

At operation 703, the column classification manager 400, for each category in the list of categories, applies a respective scoring model to the features in the column to generate a respective set of confidence values indicating a likelihood that the column belongs to a respective one of the categories, as discussed above.

At operation 704, the column classification manager 400 processes the respective sets of confidence values to select a target category from the list of categories, as discussed above.

At operation 705, the column classification manager 400 associates the selected target category with the column of features, as discussed above.

Described implementations of the subject matter can include one or more features, alone or in combination as illustrated below by way of example.

Example 1. A system comprising: at least one hardware processor; and at least one memory storing instructions that cause the at least one hardware processor to execute operations comprising: accessing a table associated with features of a column (e.g., features that are generated based on entries of the column); retrieving a list of categories each associated with a different scoring model; for each category in the list of categories, applying a respective scoring model to the features of the column to generate a respective set of confidence values indicating a likelihood that the column belongs to a respective one of the categories; processing the respective sets of confidence values to select a target category from the list of categories; and associating the selected target category with the column.

Example 2. The system of Example 1, wherein the features are derived from data entries of the column.

Example 3. The system of any one of Examples 1-2, wherein the features are derived from a column name.

Example 4. The system of any one of Examples 1-3, the operations further comprising: for a first category in the list of categories, applying a first scoring model to the features in the column to generate a first set of confidence values indicating a likelihood that the column belongs to the first category.

Example 5. The system of Example 4, the operations further comprising: for a second category in the list of categories, applying a second scoring model to the features in the column to generate a second set of confidence values indicating a likelihood that the column belongs to the second category; and processing the first set of confidence values and the second set of confidence values to select the target category from the first and second categories.

Example 6. The system of any one of Examples 1-5, wherein each confidence value in the respective sets of confidence values is associated with a different score.

Example 7. The system of any one of Examples 1-6, wherein the scoring model generates a distribution of scores for the features of the column as belonging to a first category in the list of categories as a first set of confidence values, the distribution of scores comprising a first percentage of the features of the column having a first likelihood of belonging to the first category, a second percentage of the features of the column having a second likelihood of belonging to the first category, and a third percentage of the features of the column having a third likelihood of belonging to the first category.

Example 8. The system of Example 7, wherein the first likelihood is greater than the second likelihood, and wherein the second likelihood is greater than the third likelihood.

Example 9. The system of Example 8, the operations further comprising: determining that the first percentage is greater than a threshold value; and in response to determining that the first percentage is greater than the threshold value, generating an aggregate confidence value that the column belongs to the first category as a sum of a first portion of confidence values of the first set of confidence values associated with the first likelihood and a second portion of confidence values of the first set of confidence values associated with the second likelihood.

Example 10. The system of Example 9, the operations further comprising: determining that a first feature of the column of features comprises a column name; obtaining a confidence value from the first set of confidence values corresponding to the first feature comprising the column name; and selectively increasing the aggregate confidence value by a first amount or a second amount based on the confidence value of the first feature comprising the column name, the second amount being smaller than the first amount.

Example 11. The system of Example 10, the operations further comprising: determining that the confidence value corresponds to the first likelihood; and in response to determining that the confidence value of the first feature comprising the column name corresponds to the first likelihood, increasing the aggregate confidence value by the first amount.

Example 12. The system of any one of Examples 10-11, the operations further comprising: determining that the confidence value corresponds to the second likelihood; and in response to determining that the confidence value of the first feature comprising the column name corresponds to the second likelihood, increasing the aggregate confidence value by the second amount.

Example 13. The system of any one of Examples 9-12, wherein the aggregate confidence value is a first aggregate confidence value, the operations further comprising: generating a second aggregate confidence value that the column belongs to a second category based on a second set of confidence values associated with the features of the column; comparing the first aggregate confidence value with the second aggregate confidence value; and selecting the target category from the first and second categories in response to comparing the first aggregate confidence value with the second aggregate confidence value.

Example 14. The system of Example 13, the operations further comprising: determining that the second aggregate confidence value is greater than the first aggregate confidence value in response to comparing the first aggregate confidence value with the second aggregate confidence value; and selecting the second category as the target category in response to determining that the second aggregate confidence value is greater than the first aggregate confidence value.

Example 15. The system of any one of Examples 1-14, the operations further comprising: accessing a plurality of machine learning models each associated with a different category in the list of categories; and applying a first machine learning model of the plurality of machine learning models to the features in the column to generate a first set of confidence values corresponding to a first category in the list of categories.

Example 16. The system of Example 15, the operations further comprising: applying a second machine learning model of the plurality of machine learning models to the features in the column to generate a second set of confidence values corresponding to a second category in the list of categories.

Example 17. The system of any one of Examples 1-16, wherein the scoring model for a first category comprises a predefined list of attributes associated with the first category, the operations further comprising: determining that a first feature of the column of features matches one or more attributes in the predefined list of attributes; and generating a first confidence value of a first set of confidence values of the column for the first feature based on determining that the first feature of the column of features matches the one or more attributes in the predefined list of attributes.

Example 18. The system of Example 17, the operations further comprising: determining that a second feature of the column of features fails to match the one or more attributes in the predefined list of attributes; and generating a second confidence value of the first set of confidence values of the column for the second feature based on determining that the second feature of the column of features fails to match the one or more attributes in the predefined list of attributes.

Example 19. The system of Example 18, the operations comprising: computing the first set of confidence values for the column as a function of the first and second confidence values.

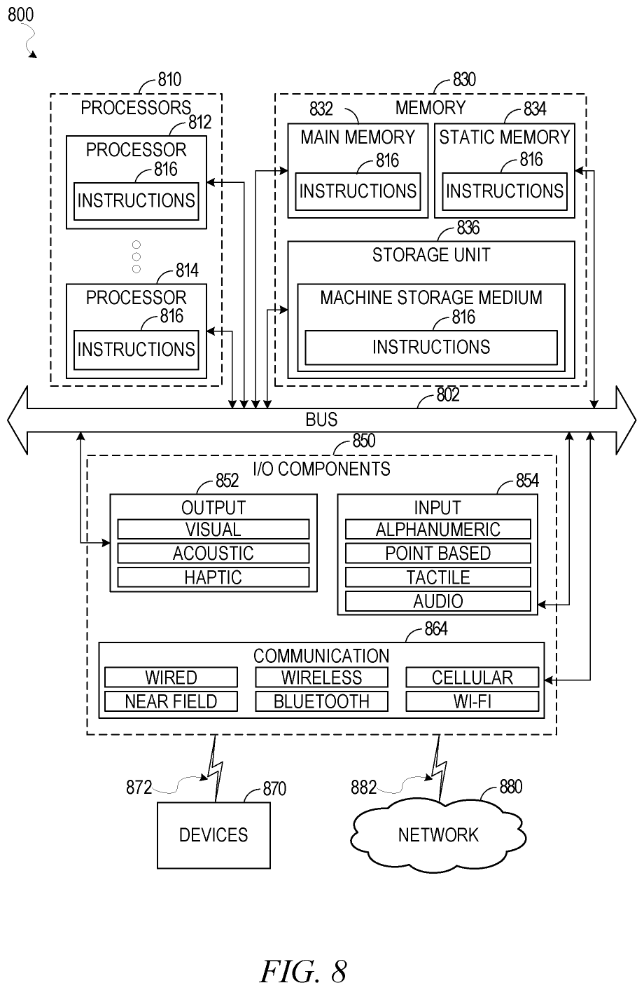

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of the above processes (e.g., method 700). In this way, the instructions 816 transform a general, non-programmed machine into a particular machine 800 (e.g., the compute service manager 108 or one or more execution nodes of the execution platform 110) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include any other computing device described herein as being in communication with the data platform 102.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple transitory or non-transitory storage devices and/or media (e.g., a centralized or distributed database, and/or associated caches and servers) that store executable transitory or non-transitory instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the process or method 700 may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to execute operations comprising:
accessing a table associated with features of a column;
retrieving a list of categories, each category in the list of categories being associated with a different scoring model;
for each category in the list of categories, applying a respective scoring model to the features of the column to generate a respective set of confidence values indicating a likelihood that the column belongs to a respective one of the categories;
processing the respective sets of confidence values to select a target category from the list of categories; and
associating the selected target category with the column.

2. The system of claim 1, wherein the features are derived from data entries of the column.

3. The system of claim 2, wherein the features are derived from a column name.

4. The system of claim 1, the operations further comprising:
for a first category in the list of categories, applying a first scoring model to the features in the column to generate a first set of confidence values indicating a likelihood that the column belongs to the first category.

5. The system of claim 4, the operations further comprising:
for a second category in the list of categories, applying a second scoring model to the features in the column to generate a second set of confidence values indicating a likelihood that the column belongs to the second category; and
processing the first set of confidence values and the second set of confidence values to select the target category from the first and second categories.

6. The system of claim 1, wherein each confidence value in the respective sets of confidence values is associated with a different score.

7. The system of claim 1, wherein the scoring model generates a distribution of scores for the features of the column as belonging to a first category in the list of categories as a first set of confidence values, the distribution of scores comprising a first percentage of the features of the column having a first likelihood of belonging to the first category, a second percentage of the features of the column having a second likelihood of belonging to the first category, and a third percentage of the features of the column having a third likelihood of belonging to the first category.

8. The system of claim 7, wherein the first likelihood is greater than the second likelihood; and
wherein the second likelihood is greater than the third likelihood.

9. The system of claim 8, the operations further comprising:
determining that the first percentage is greater than a threshold value; and
in response to determining that the first percentage is greater than the threshold value, generating an aggregate confidence value that the column belongs to the first category as a sum of a first portion of confidence values of the first set of confidence values associated with the first likelihood and a second portion of confidence values of the first set of confidence values associated with the second likelihood.

10. The system of claim 9, the operations further comprising:
determining that a first feature of the column of features comprises a column name;
obtaining a confidence value from the first set of confidence value corresponding to the first feature comprising the column name; and
selectively increasing the aggregate confidence value by a first amount or a second amount based on the confidence value of the first feature comprising the column name, the second amount being smaller than the first amount.

11. The system of claim 10, the operations further comprising:
determining that the confidence value corresponds to the first likelihood; and
in response to determining that the confidence value of the first feature comprising the column name corresponds to the first likelihood, increasing the aggregate confidence value by the first amount.

12. The system of claim 10, the operations further comprising:
determining that the confidence value corresponds to the second likelihood; and
in response to determining that the confidence value of the first feature comprising the column name corresponds to the second likelihood, increasing the aggregate confidence value by the second amount.

13. The system of claim 9, wherein the aggregate confidence value is a first aggregate confidence value, the operations further comprising:
generating a second aggregate confidence value that the column belongs to a second category based on a second set of confidence values associated with the features of the column;
comparing the first aggregate confidence value with the second aggregate confidence value; and
selecting the target category from the first and second categories in response to comparing the first aggregate confidence value with the second aggregate confidence value.

14. The system of claim 13, the operations further comprising:
determining that the second aggregate confidence value is greater than the first aggregate confidence value in response to comparing the first aggregate confidence value with the second aggregate confidence value; and
selecting the second category as the target category in response to determining that the second aggregate confidence value is greater than the first aggregate confidence value.

15. The system of claim 1, the operations further comprising:
accessing a plurality of machine learning models each associated with a different category in the list of categories; and
applying a first machine learning model of the plurality of machine learning models to the features in the column to generate a first set of confidence values corresponding to a first category in the list of categories.

16. The system of claim 15, the operations further comprising:
applying a second machine learning model of the plurality of machine learning models to the features in the column to generate a second set of confidence values corresponding to a second category in the list of categories.

17. The system of claim 1, wherein the scoring model for a first category comprises a predefined list of attributes associated with the first category, the operations further comprising:
determining that a first feature of the column of features matches one or more attributes in the predefined list of attributes; and
generating a first confidence value of a first set of confidence values of the column for the first feature based on determining that the first feature of the column of features matches the one or more attributes in the predefined list of attributes.

18. The system of claim 17, the operations further comprising:
determining that a second feature of the column of features fails to match the one or more attributes in the predefined list of attributes;
generating a second confidence value of the first set of confidence values of the column for the second feature based on determining that the second feature of the column of features fails to match the one or more attributes in the predefined list of attributes; and
computing the first set of confidence values for the column as a function of the first and second confidence values.

19. A method comprising:
accessing, by at least one hardware processor, a table associated with features of a column;
retrieving a list of categories, each category in the list of categories being associated with a different scoring model;
for each category in the list of categories, applying a respective scoring model to the features of the column to generate a respective set of confidence values indicating a likelihood that the column belongs to a respective one of the categories;
processing the respective sets of confidence values to select a target category from the list of categories; and
associating the selected target category with the column.

20. A computer-storage medium comprising instructions that, when executed by a processor of a machine, configure the machine to perform operations comprising:
accessing a table associated with features of a column;
retrieving a list of categories, each category in the list of categories being associated with a different scoring model;
for each category in the list of categories, applying a respective scoring model to the features of the column to generate a respective set of confidence values indicating a likelihood that the column belongs to a respective one of the categories;
processing the respective sets of confidence values to select a target category from the list of categories; and
associating the selected target category with the column.
